(19) United States
(12) Patent Application Publication
(10) Pub. No.: US 2005/0144059 A1
(43) Pub. Date: Jun. 30, 2005

(54) Personal intelligent shipment system and method

(76) Inventor: Frederick Schuessler, Baiting Hollow, NY (US)

Correspondence Address: FAY KAPLUN & MARCIN, LLP, 15O BROADWAY, SUITE 702, NEW YORK, NY, 10038, US

(21) Appl. No.: 10/748,400

(22) Filed: Dec. 30, 2003

(51) Int. Cl. G06F 17/60

(52) U.S. Cl. 705/9; 705/1

(57) ABSTRACT

Described is a method and system for providing a user with a personalized shipment system. The user is registered by providing user data which is associated with a unique user identifier. Label data is generated for each of a plurality of labels. Each label includes a unique label identifier in a machine language. The label identifier is associated with the user identifier in a computer database. An item to be shipped is received; the item includes one of the labels and recipient data which includes a destination data of the item. Determination is made whether the destination data is in a machine language. When the destination data is not in a machine language, the destination data is translated into machine language destination data. The unique label identifier and the machine language destination data are obtained from the item using a machine capable of reading the machine language during the shipment of the item. The tracking data is recorded the computer database based on the machine language unique label identifier and the machine language data. The tracking data regarding shipment progress of the item is provided in response to a request referencing at least one of the user identifier and the destination data.

### BACKGROUND

Some conventional mailing services (e.g., FedEx, UPS, etc.) allow consumers to track movements of packages as they are being shipped through their mailing service systems. In order to obtain such tracking information, the consumer must fill out a shipping declaration for each package including the consumer's data and destination information. The mailing service then, using the above-mentioned information and a serial number of the declaration, allows the consumer to track the movement of the package through the mailing service system until the package reaches its destination.

Such mailing system may work well for occasional package shipments. However, such mailing system may be far too cumbersome for the consumers who desire to track movements of every piece of mail they send.

### SUMMARY OF THE INVENTION

Described is a method and system for providing a user with a personalized shipment system. The user is registered by providing user data which is associated with a unique user identifier. Label data is generated for each of a plurality of labels. Each label includes a unique label identifier in a machine language. The label identifier is associated with the user identifier in a computer database. An item to be shipped is received; the item includes one of the labels and recipient data which includes a destination data of the item.

Determination is made whether the destination data is in a machine language. When the destination data is not in a machine language, the destination data is translated into machine language destination data. The unique label identifier and the machine language destination data are obtained from the item using a machine capable of reading the machine language during the shipment of the item. The tracking data is recorded the computer database based on the machine language unique label identifier and the machine language data. The tracking data regarding shipment progress of the item is provided in response to a request referencing at least one of the user identifier and the destination data.

### BRIEF DESCRIPTION OF THE DRAWINGS

The accompanying drawings are included to provide a further understanding of the invention and are incorporated in and constitute part of the specification, illustrate several embodiments of the invention and, together with the description, serve to explain examples of the present invention. In the drawings:

FIG. 1 is an exemplary intelligent shipment system according to the present invention;

FIG. 2a shows an exemplary embodiment of marked envelope utilized by the system according to the present invention;

FIG. 2b shows another exemplary embodiment of marked envelope utilized by the system;

FIG. 3 shows an exemplary embodiment of a method according to the present invention;

FIG. 4a shows an exemplary embodiment of a tracking number utilized by the system according to the present invention;

FIG. 4b shows another exemplary embodiment of the tracking number;

FIG. 5a shows an exemplary embodiment of a mail outbox of sender which utilizes the system according to the present invention; and

FIG. 5b shows an exemplary embodiment of a mail inbox of recipient which utilizes the system.

### DETAILED DESCRIPTION

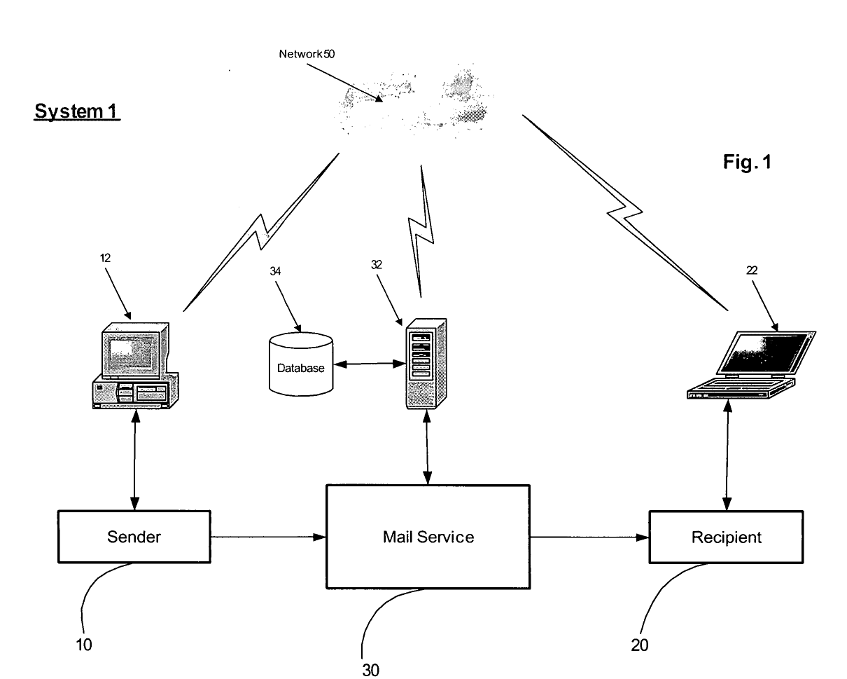

FIG. 1 shows an exemplary embodiment of a personal intelligent shipment system 1 according to the present invention. The system 1 allows marking of an individual item to be shipped (e.g., a piece of mail) with a unique identification so that the item may be automatically scanned and tracked as it moves through the system 1. The system 1 is available to all users who desire to track their everyday mail and, in particular, individual consumers and small businesses.

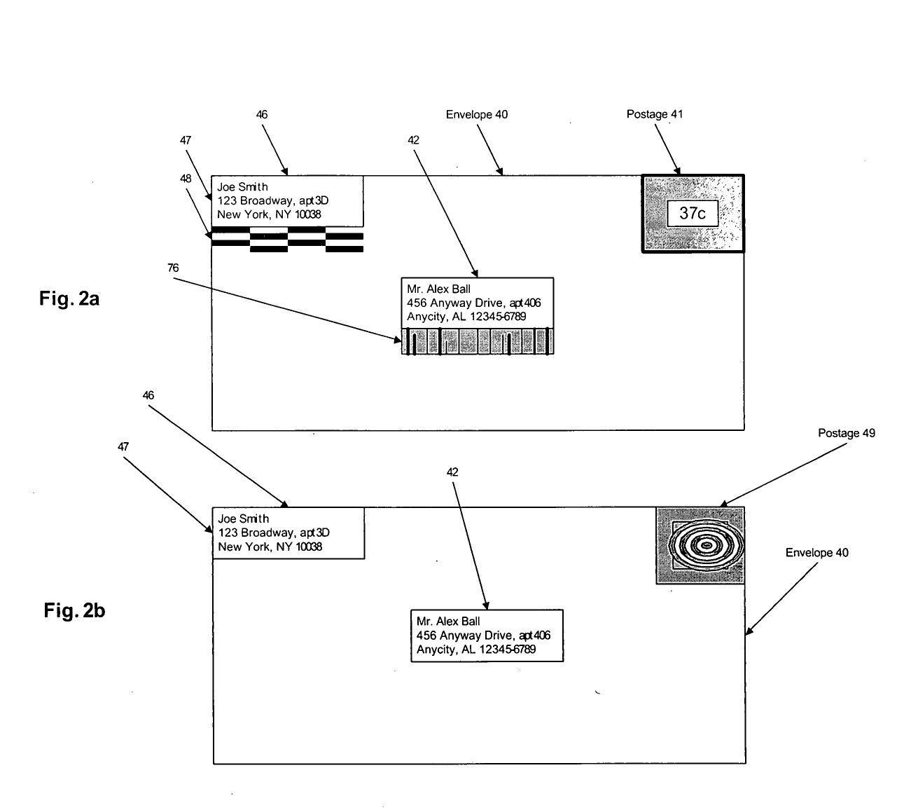

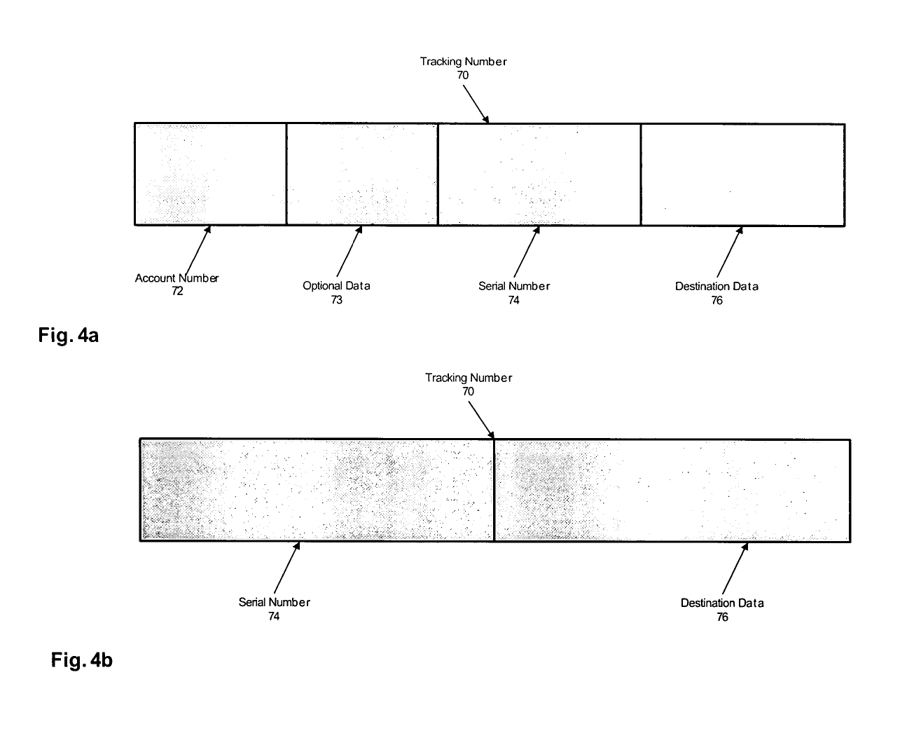

For example, Sender 10 desires to send a piece of mail, such as an envelope 40 (as shown in FIGS. 2a and 2b), a package, a box, etc., to Recipient 20 using Mail Service 30. Mail Service 30 may be, for example, the US Postal Service or any other service that ships mail or other items. Sender 10 marks the envelope 40 with predetermined information and provides it to Mail Service 30. Based on the predetermined information, Mail Service 30 tracks the envelope 40 using a tracking number 70 as shown in FIGS. 4a and 4b. While the envelope 40 is being shipped by Mail Service 30 to Recipient 20, movements of the envelope 40 along with other related data are being recorded and stored in a database 34 of a Mail Service's computer 32. This data may be accessed before and/or after the envelope 40 is received by Recipient 20.

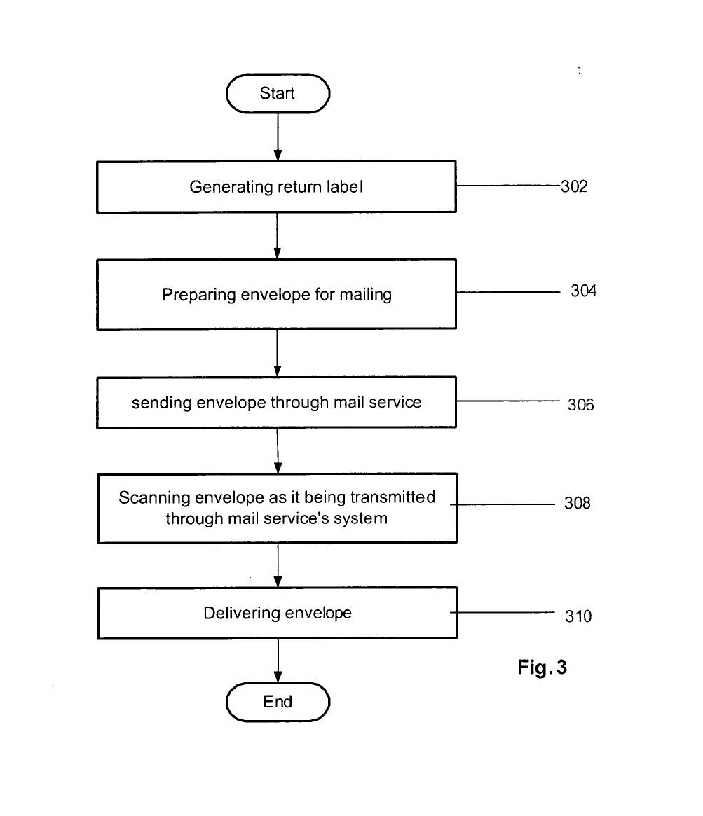

FIG. 3 shows an exemplary embodiment of a method according to the present invention. In step 302, a return label 46 for the envelope 40 is generated based on sender's information and a unique label identifier (e.g., a serial number). In particular, FIG. 4a shows an exemplary embodiment of the return label 46 which may have a first portion 47 and a second portion 48.

The first portion 47 may include the name and address of Sender 10. The second portion 48 may include, for example, the Sender's account number 72 and a unique serial number 74 stored in, for example, a bar code (as shown in FIG. 4a). Those skilled in the art would understand that data which can be stored in the form of barcode may also be stored in an conventional RFID tag (not shown). The account number 72 is a unique number assigned to each Sender 10 by Mail Service 30 or a designated third party. For example, Sender 10 may obtain the account number 72 during his registration with Mail Service 30. The account number 72 along with Sender's data (e.g., name, address, credit card number, phone, preferences, etc.) may be stored in the database 34. The serial number 74 is an identification number which is unique to every return label 46. Thus, the serial number 74 allows unique identification of each piece of mail.

In an alternative exemplary embodiment of the present invention, the second portion 48 may also include optional data 73. The optional data 73 may be a text message for Recipient 20, delivery instructions for Mail Service 30, etc. In another alternative embodiment, the second portion 48 may only include the serial number 74. In this embodiment, the sender's account number 72 is associated with the particular serial number 74 when Sender 10 purchases the return labels 46 with the account, i.e., the correlation is made in the database 34 without actually printing the account number 72 in the second portion 48. Those of skill in the art will understand that the second portion 48 may also be separate from a return label and may be attached to the item in various manners, e.g., attached via a label, printed by Sender 10 directly on the item after receiving a series of serial numbers 74 from Mail Service 30, etc.

The data included in the second portion 48 may be stored in the form of a two-dimensional barcode (e.g., PDF 417 barcode). The return label 46 may be generated and printed the Sender 10; alternatively, the returned label 46 may generated and sold to Sender 10 by Mail Service 30, designated third-part providers, mail-order companies, etc. For example, if a third-party generates the return labels 46, Mail Service 30 may reserve up to 99 two-digit combinations at the start of the return label 46 to uniquely identify up to 99 licensed third-parities (00 may be reserved for Mail Service 30 itself). Each of those third-parties could then make up the remainder of their serial numbers independent of Mail Service 30 and independent of each other, yet the numbers would still be unique identifiers. Sender 10 could purchase a set of these third-party labels, then bring a sheet of 30 labels into a local office of Mail Service 30, where it would scan Sender 10's ID card then scan a label at the top of the return labels 46's sheet. Now, Mail Service 30's computers 12 associated Sender 10's ID with this set of third-party label identification even through Mail Service's computers 12 did not generate the set of return labels 46.

The return label 46 may include preset optional data 73 (e.g., a text massage “Happy Holidays!”) or predefined nicknames of Sender 10 (e.g., “Uncle Joe”). Alternatively, the return label 46 may be generated by Sender 10 utilizing a dedicated software program or hardware. The hardware for generating labels 46 may include a conventional bar code writer and/or a conventional RFID tag writer.

In step 304, Sender 10 prepares the envelope 40 for mailing. In particular, Sender 10 attaches the return label 46 to the envelope 40. In addition, Sender 10 provides destination data (e.g., Recipient's address 42 on the envelope 40, etc.). The Recipient's address 42 may be typed, printed, handwritten or any other form as long as it may be recognized by machines of Mail Service 30. Optionally, Sender 10 may also provide Recipient's destination data 76 which may be coded with a destination address code. The destination address code may be stored in, e.g., a bar code or an RFID tag. For example, the destination address code may be a PostNet bar code which contains an extended form of Recipient's zip code which is detailed enough to distinguish between different Recipients 20. An example of extended form of the zipcode may be (i) “zip plus 4” or a 9-digit zip; or (ii) “destination point zipcode” or a full 11-digit zip.

Finally, Sender 10 attaches an appropriate postage 41, and the envelope 40 is ready to be mailed. The postage 41 may be in the form of a conventional prepaid stamp, an imprint from a postage machine (e.g., a Pitney Bowes Personal Postoffice machine) or a two-dimensional barcode Information Based Indicia “IBI” postage (e.g., PDF 417).

In an alternative exemplary embodiment of the present invention, the IBI postage 49, as shown in FIG. 2b, may also store at least some of the data which is marked on the envelope 40. In particular, the IBI postage 49 may include data stored in the return label 46, the Recipient's data 42 and the destination data 76. Thus, there may be no need to include the second portion 48 and/or the destination data 76. Those skilled in the art would understand that steps 302 and 304 may be integrated into a single step.

In step 306, the envelope 40 is sent by Sender 10, using Mail Service 30, to be delivered to Recipient 20. When Mail Service 30 receives the envelope 40, its sorting machine checks the envelope 40 for destination data 76 in a machine language. That is, the sorting machine checks for data encoded on the envelope 40 in a form specifically designed for reading by machines (e.g., bar codes) which are not readily readable by humans without prior translation by a machine. If such data 76 is not provided on the envelope 40 in a machine language, the sorting machine searches for destination information in a human language (e.g., typed or handwritten English). The sorting machine then translates this information into machine language destination data 76 (e.g., using character recognition) and marks the destination data 76 on the envelope 40. As would be understood by those skilled in the art, the sorting machine may include any or all of a bar code reader, a bar code writer, an RFID tag reader and an RFID tag writer along with an optical scanner and character recognition software. Thus, the sorting machine may read data 76 when presented, for example, in a bar code or via an RFID tag, or may recognize a written address and translate it into data 76 which then may be marked on the envelope using, for example, the bar code writer or the RFID tag writer.

Subsequently, during the shipment of the envelope 40 to Recipient 20, the Mail Service 30 sorts/transmits and scans the envelope 40, as explained below, and stores the data obtained during the scan in the database 34 (step 308). In particular, Mail Service 30 uses the machine (e.g., sorting machines, etc.) for processing the envelope 40. When the envelope 40 is processed by the machine, a tracking number 70 as shown in FIGS. 4a and 4b and described below, is generated for the particular process (e.g., a scanning of the envelope process) by associating the serial number 74 with the designation data 76.

Data obtained from each scan may be stored in the database 34. A software program (which may be run on the computer 32) may process recently stored scans, detect fraudulently re-use and associate each scanned tracking number 70 with Sender's account 72. Such in-process scans only capture and store a small amount of information in the database 34 (e.g., the serial number 74, the destination data 76 and the date/time/location of each scan). At the time of scan, no retrieval operation from the database 34 is required. The database 34 look-ups occur when there is a request from a user. The request may be a specific demand for information regarding a particular envelope 40, a status of the envelope 40 for particular Sender 10, etc.

In alternative exemplary embodiment of the present invention, the system 1 allows near real time look ups. In other words, every time the envelope 40 is scanned, the data of the scan is processed and all corresponding files are updated in near real time. For example, when the scan occurs Sender 10 is informed via instant messaging to a cell phone via an email message, etc.

In step 310, Mail Service 30 delivers the envelope 40 to Sender 20. Mail Service 30 may offer optional services, such as a delivery confirmation service. If Sender 10 opts for the delivery confirmation service, then upon delivery of the envelope 40 to Recipient 20, Mail Service 30 (e.g., using a portable scanner) would scan the return label 46 and provide the corresponding information to Sender 10.

FIG. 4a shows an exemplary tracking number 70 which may include the Sender's account number 72, the serial number 74 and the destination code 76. The tracking number 70 may also include optional data 73. Alternatively, the tracking number 70, as shown in FIG. 4b, includes only the serial number 74 and the destination code 76. The tracking number 70 may be obtained from “reading” the second portion 48 and the destination data 76. Alternatively, the tracking number 70 may be generated from the data stored in the IBI postage 49.

The system 1 allows Sender 10, Recipient 20, Mail Service 30 or any other authorized person to obtain information about the envelope 40 during and/or after the shipment of the envelope 40 through the system 1.

In particular, Sender 10/Recipient 20 may obtain certain data using computers 12, 22 which are linked to the computer 32 via a communication network 50 as shown in FIG. 1. The communication network 50, for example, may be the Internet, a local area network, a wide area network, etc. In addition, the communication network 50 may be a partially wired and wireless network. In the alternative or addition, Sender 10/Recipient 20 may access the information using the computer 32 which may be located in an office of Mail Service 30.

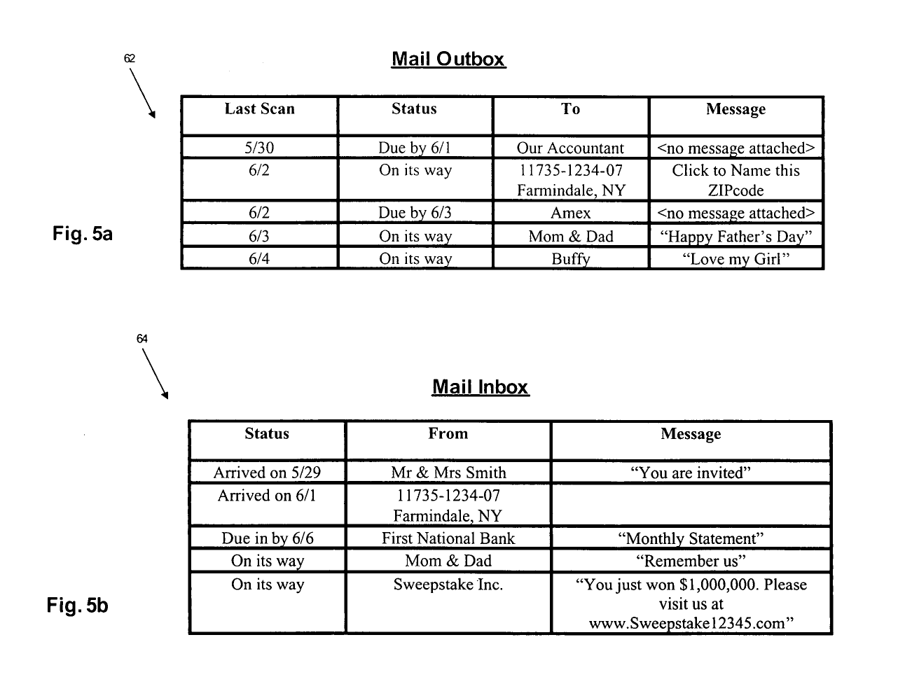

For example, Sender 10 may view data regarding the envelope 40 which was sent to Sender 20. FIG. 5a shows a screen shot of an exemplary mail outbox of Sender 10. For each envelope 40, there may be the following information: date of the last scan; date of arrival; a class of mail (e.g., “First Class”, “Express Mail”, etc.); status information (e.g., “On its way”, “Arrived”, etc.); Recipient's identification 42 or Recipient's Nickname (e.g., “117-1234-07 Farmindale, N.Y.”, “Mom & Dad”); the optional data 73 (e.g., “Happy Farther's Day!”, “Family Newsletter”, etc.), etc. The system 1 may also allow Sender 10 to not reveal its name (i.e., the system 1 would display Sender's 10 identification as “anonymous”).

Similarly, Recipient 20 may view the envelope 40 that he already received and/or is about to receive. FIG. 5b shows a screen shot of an exemplary mail inbox of Recipient 20. For each envelope 40, there may be the following information: status information (e.g, “Arrived 5/29“, “Due in by 6/5”), etc.); Sender's information 42 (e.g., “Anonymous”, “Mom & Dad”, etc.); the optional data 43 (e.g., “You're Invited”, “Water Bill”, etc.), etc.

It should noted that the “To” field of the outbox and the “From” field of the inbox contain information obtained only from the postal zipcode. For example, the “To” field of the outbox would have only “11229-1234”. In order to provide more complete additional information to Recipient 20 must associate the zipcode with such additional information. For instance, Recipient 20 may set up the following associations: “11226-1234” is the postal code of Uncle Steve.

It should be noted that such associations may vary according to classifications set up by the user. For example, if the envelope 40 is sent to a friend, then show sender as “Alex”; however, if it is sent to Chase Bank, then show sender as “Mr. Alex Smith”.

Although FIGS. 5a & 5b are shown as black-and-white, those skilled in the art would understand that the illustrated tables may be color coded for easier comprehension of the information. For example, if the status information is red, then it may indicate that the envelope 40 has yet to be delivered. On the other hand, if the status information is green, then the envelope 40 was already delivered to Recipient 20.

The system 1 allows creation of multiple accounts for each Sender 10 (e.g., children may have separate accounts than their parents, etc.). The system 1 also may allow multiple accounts for each Recipient 20. In such a case, each Recipient's account must be preset and specified in the return label 46. Furthermore, Sender 10 may specify which Recipient 20 or a group of Recipients 20 may review information about the incoming mail. For example, Sender 10 may set that only parents may preview the information about the incoming mail, but not the children, etc.

In addition, Sender 10 is not required to perform additional steps for sending the envelope 40 (with the exception of obtaining of the preset return labels 46). Thus, the Sender 10 can utilize the system 1 without the need to use a computer or even have access to one. Since the return label 46 includes the Sender's account number 72 and the serial number 74 and the Mail Service 30 may read the Recipient's address 42 to generate the destination data 76, each envelope 40 is uniquely marked for tracking by Mail Service 30. Thus, the exemplary embodiment of the present invention has the capability to provide as many digits as is required for storing information about an item (e.g., 12 digits). The system 1, unlike conventional mailing systems which are mostly available to large businesses, can be available and utilized by individual consumers and small businesses.

Furthermore, the tracking number 70 is in machine-readable form and may be automatically read by existing Mailing Service 30 machines. Thus, the system 1 does not require new equipment to be purchased by the Mail Service 30.

The system 1 also provides the user with an easy-to-use Graphical User Interface (“GUI”). In addition, Sender 10/Recipient 20 does not have to know the tracking number 70 of each envelope 40 that is being sent/received; in other words, the tracking number 70 may be “invisible”. By using the Sender's account number 72 or the destination data 76, one may track the movements of the envelope 40. This allows not only the tracking of the movements of the envelope 40 that is sent, e.g., by Sender 10, but also allows Recipient 20 to track movement of the envelopes 40 that are being sent to Recipient 20. Thus, an advance notice to Recipient 20 may be provided that he should be expecting the envelope 40. In addition, to the notice, Recipient 20 may also receive a customized message. This feature may be especially valuable for marketing purposes. For example, Recipient 20 may receive an advance notification “Watch your mail for this special offer.”

The exemplary embodiment of the present invention also allows Sender 10 to receive confirmation that the envelope 40 was received by Recipient 20. In addition, the present invention increases convenience of postal boxes (“P.O. Box”) because Recipient 20 may find out in advance whether the postal box has any mail of interest; thus, making a trip for Recipient 20 to the postal box worth while.

The Mail Service 30 may increase its revenues by offering a wide variety of addition services. For example, Mail Service 30 may generate addition revenues from the sale of Return Labels 46; prepaid accounts that Sender 10 and/or Recipient 20 may establish; usage of the delivery confirmation service; increased usage of P.O. Boxes; etc.

Unlike conventional mailing services, Sender 10 does not have to record a newly assigned tracking number for each piece of mail, instead, the tracking number 70 is generated based on information provided on “a face” of the envelope 40 (i.e., the second portion 48 and the destination data 76).

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

1. A method for providing a user with a personalized shipment system, comprising:
registering a user by obtaining user data;
associating the user data with a unique user identifier;
generating label data for each of a plurality of labels, each label including a unique label identifier in a machine language;
associating the label identifier with the user identifier in a computer database;
receiving an item to be shipped including one of the labels and recipient data including a destination data of the item;
determining whether the destination data is in a machine language;
translating, when the destination data is not in a machine language, the destination data into machine language destination data;
obtaining the unique label identifier and the machine language destination data from the item using a machine capable of reading the machine language during the shipment of the item;
recording in the computer database tracking data based on the machine language unique label identifier and the machine language data; and
providing the tracking data regarding shipment progress of the item in response to a request referencing at least one of the user identifier and the destination data.

2. The method according to claim 1, wherein the machine language unique label identifier and the machine language destination data are stored on the item in form one of a barcode and an RFID tag.

3. The method according to claim 1, further comprising:
generating, using the label data, the plurality of labels by at least one of the user, a postal delivery service and a predetermined third party provider.

4. The method according to claim 1, wherein the tracking data includes time data and location data corresponding to the scanning.

5. The method according to claim 1, wherein the label data is stored in at least one of a barcode and an RFID tag.

6. The method according to claim 1, wherein the machine language destination data includes at least one recipient name and a recipient address code.

7. The method according to claim 6, wherein the machine language destination data includes a further code identifying each of a plurality of recipient names which have the same recipient address code.

8. The method according to claim 1, wherein the label data includes optional additional data generated by the user.

9. The method according to claim 1, wherein the label data, the destination data and postage data are stored on the label as a two-dimensional barcode.

10. The method according to claim 6, further comprising:
associating by the user the recipient address code with a predetermined recipient identifier.

11. The method according to claim 8, wherein the tracking data includes the optional additional data.

12. The method according to claim 1, wherein the tracking data includes an arrival date indicative of one of an actual date and an estimated date of arrival of the item at the destination.

13. A system for providing a user with a personalized shipment system for shipment of an item, comprising:
a first computing arrangement generating label data for each of a plurality of labels, each label including a unique label identifier in a machine language;
a second computing arrangement including a database and storing user data in the database, the second computing arrangement associating the user data with a unique user identifier and associating the unique label identifier with the user identifier in the database;
a first shipment processing arrangement receiving an item to be shipped, the item including one of the labels and recipient data including destination data of the item, the first shipment processing arrangement determining whether the destination data is in a machine language and, when the destination data is not in a machine language, the first shipment processing arrangement translates the destination data into the machine language destination data and marks the item with the machine language destination data; and
a second shipment processing arrangement obtaining the machine language unique label identifier and the machine language destination data from the item during the shipment, the second shipment processing arrangement recording in the database tracking data based on the association of the label identifier and the destination data,
wherein the tracking data is provided by the second computing arrangement in response to a request referencing at least one of the user identifier and the destination data.

14. The system according to claim 13, wherein the machine language unique label identifier and the machine language destination data are stored on the item in one of a barcode and an RFID tag, and wherein the first shipment processing arrangement includes at least one of a barcode reader, a barcode writer, an RFID tag reader and an RFID tag writer.

15. The system according to claim 13, further comprising:
a printing arrangement generating the plurality of labels by at least one of the user, a postal delivery service and a predetermined third party provider using the label data.

16. The system according to claim 15, wherein the printing arrangement includes at least one of a barcode writer and an RFID tag writer.

17. The system according to claim 13, wherein the tracking data includes time and location data corresponding to receipt of the item by the second shipment processing arrangement.

18. The system according to claim 13, wherein the machine language recipient data includes at least one recipient name and a recipient address code.

19. The system according to claim 18, wherein the machine language destination data includes a further code identifying each of a plurality of recipient names which have the same recipient address code.

20. The system according to claim 13, wherein the label data includes optional additional data generated by the user.

21. The system according to claim 13, wherein the label data, the machine language recipient data and postage data are stored on the label as a two-dimensional barcode.

22. The system according to claim 18, wherein the user associates the recipient address with a recipient identifier.

23. The system according to claim 20, wherein the machine language recipient data includes a further code indicative of each of a plurality of recipients located at the destination.

24. The system according to claim 13, wherein the tracking data includes an arrival date indicative of one of an actual date and an estimated date of arrival of the item at the destination.
